(19) United States
(12) Patent Application Publication
(10) Pub. No.: US 2023/0292395 A1
(43) Pub. Date: Sep. 14, 2023

(54) METHOD AND APPARATUS FOR ALIGNING SIDELINK DRX

(71) Applicant: Lenovo (Beijing) Limited, Beijing (CN)

(72) Inventors: Jing HAN, Beijing (CN); Lianhai WU, Beijing (CN); Ran YUE, Beijing (CN); Jie HU, Beijing (CN); Haiming WANG, Beijing (CN)

(21) Appl. No.: 18/005,810

(22) PCT Filed: Jul. 17, 2020
(86) PCT No.: PCT/CN2020/102714

§ 371 Date: Jan. 17, 2023

(51) Int. Cl. H04W 76/28

(52) U.S. Cl. CPC H04W 76/28

(57) ABSTRACT

The present application relates to a method and apparatus for aligning sidelink DRX. One embodiment of the subject application provides a method performed by a transmitting UE, which includes receiving a first signalling, which indicates a first SL DRX configuration, from a Base Station (BS); and transmitting, to a receiving UE, a second signalling which indicates a second SL DRX configuration, wherein the second SL DRX configuration is determined based on the first SL DRX configuration.

### CROSS REFERENCE TO RELATED APPLICATIONS

This application is a national phase entry of International Application No. PCT/CN2020/102714, filed on Jul. 17, 2020, entitled METHOD AND APPARATUS FOR ALIGNING SIDELINK DRX, which is incorporated by reference in its entirety.

### TECHNICAL FIELD

The subject application relates to wireless communication technology, and more particularly, related to a method and apparatus for aligning sidelink (SL) discontinuous reception (DRX).

### BACKGROUND OF THE INVENTION

In 3GPP (3rd Generation Partnership Project) Release 16, the NR (New Radio) sidelink assumes that the UEs (User Equipment) are always wake up and monitor sidelink control channels during a sidelink communication. In other words, the sidelink only focuses on the UEs installed in vehicles with sufficient battery capacity. In Release 17, in order to save power for the UEs with battery constraint, the DRX configuration including parameters such as on-duration, off-duration, and wake-up time are introduced to sidelink communication.

Therefore, it is desirable to provide a solution for aligning the DRX in sidelink communication among the UEs.

### SUMMARY

One embodiment of the subject application provides a method performed by a transmitting UE, which includes receiving a first signalling, which indicates a first SL DRX configuration, from a Base Station (BS); and transmitting, to a receiving UE, a second signalling which indicates a second SL DRX configuration, wherein the second SL DRX configuration is determined based on the first SL DRX configuration.

Another embodiment of the subject application provides a method performed by a BS, comprising: transmitting a first signalling, which indicates a first SL DRX configuration, to a UE; and transmitting an indicator indicating whether the UE is allowed to transmit a second signaling, which indicates a second SL DRX configuration, to a receiving UE.

Another embodiment of the subject application provides a method performed by a receiving UE, which indicates receiving a first signalling, which indicates a first SL DRX configuration, from a transmitting UE.

Yet another embodiment of the subject application provides an apparatus, which indicates a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a transmitting UE, which includes receiving a first signalling, which indicates a first SL DRX configuration, from a Base Station (BS); and transmitting, to a receiving UE, a second signalling which indicates a second SL DRX configuration, wherein the second SL DRX configuration is determined based on the first SL DRX configuration.

Yet another embodiment of the subject application provides an apparatus, which indicates a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a BS, comprising: transmitting a first signalling, which indicates a first SL DRX configuration, to a UE; and transmitting an indicator indicating whether the UE is allowed to transmit a second signaling, which indicates a second SL DRX configuration, to a receiving UE.

Still another embodiment of the subject application provides an apparatus, which indicates a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a receiving UE, which indicates receiving a first signalling, which indicates a first SL DRX configuration, from a transmitting UE.

### BRIEF DESCRIPTION OF THE DRAWINGS

FIG. 1 illustrates an exemplary NR Vehicle to Everything (V2X) communication system 100 in accordance with some embodiments of the present disclosure.

FIG. 2 illustrates a flow chart 200 illustrating one preferred method for aligning sidelink DRX according to some embodiments of the subject application.

FIG. 3 illustrates a flow chart 300 illustrating another preferred method for aligning sidelink DRX according to some embodiments of the subject application.

FIG. 4 illustrates a method performed by a transmitting UE for aligning sidelink DRX according to a preferred embodiment of the subject disclosure.

FIG. 5 illustrates a method performed by a BS for aligning sidelink DRX according to a preferred embodiment of the subject disclosure.

FIG. 6 illustrates a method performed by a receiving UE for aligning sidelink DRX according to a preferred embodiment of the subject disclosure.

FIG. 7 illustrates a block diagram of a UE according to the embodiments of the subject disclosure.

FIG. 8 illustrates a block diagram of a BS according to the embodiments of the subject disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

The present disclosure generally relates to sidelink UEs. A sidelink UE, which transmits data according to sidelink resource(s) scheduled by a base station (BS), may be referred to as a UE for transmitting, a transmitting UE, a transmitting V2X UE, a Tx UE, a V2X Tx UE, a SL Tx UE, or the like. In the present disclosure “transmit” may refer to unicast, multicast, broadcast, etc. A sidelink UE, which receives data according to sidelink resource(s) scheduled by a BS, may be referred to as a UE for receiving, a receiving UE, a receiving V2X UE, an Rx UE, a V2X Rx UE, a SL Rx UE, or the like. The sidelink UEs may be power constraint UEs, including V2X UE, public safety UE, and commercial sidelink UE or the like.

Sidelink UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present application, Sidelink UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, Sidelink UE(s) includes wearable devices, such as smart watches, fitness bands, optical head-mounted displays, or the like. Moreover, Sidelink UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. Sidelink UE(s) may communicate directly with BS(s) via uplink (UL) communication signals.

A BS under NR V2X scenario, or the sidelink scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

ABS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

ABS may serve a number of Sidelink UEs within a serving area, for example, a cell or a cell sector via a wireless communication link. A BS may communicate directly with one or more of Sidelink UEs via communication signals. For example, a BS may serve Sidelink UEs within a macro cell.

Sidelink communication between a Tx UE and an Rx UE under NR V2X scenario includes groupcast communication, unicast communication, or broadcast communication.

Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), 3GPP LTE Release 12 and onwards, etc. It is contemplated that along with the 3GPP and related communication technology development, the terminologies recited in the present application may change, which should not affect the principle of the present application.

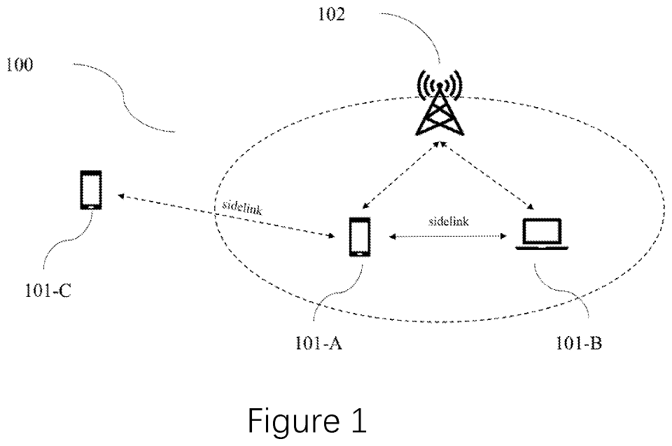

FIG. 1 illustrates an exemplary V2X communication system in accordance with some embodiments of the present application.

As shown in FIG. 1, the V2X communication system includes a base station, i.e., BS 102 and some Sidelink UEs, i.e., UE 101-A, UE 101-B, and UE 101-C. UE 101-A and UE 101-B are within the coverage of BS 102, and UE 101-C is not. UE 101-A, UE 101-B, and UE 101-C may perform sidelink unicast transmission, sidelink groupcast transmission, or sidelink broadcast transmission. It is contemplated that, in accordance with some other embodiments of the present application, a V2X communication system may include more or fewer BSs, and more or fewer Sidelink UEs. Moreover, it is contemplated that names of Sidelink UEs (which represent a Tx UE, an Rx UE, and etc.) as illustrated and shown in FIG. 1 may be different, e.g., UE 101c, UE 104f, and UE 108g or the like.

In addition, although each Sidelink UE as shown in FIG. 1 is illustrated in the shape of a car, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 1, UE 101-A functions as a Tx UE, and UE 101-B and UE 101-C function as an Rx UE. UE 101-A may exchange V2X messages with UE 101-B, or UE 101-C through a sidelink, for example, PC5 interface as defined in 3GPP documents. UE 101-A may transmit information or data to other UE(s) within the V2X communication system, through sidelink unicast, sidelink groupcast, or sidelink broadcast. For instance, UE 101-A transmits data to UE 101-B in a sidelink unicast session. UE 101-A may transmit data to UE 101-B and UE 101-C in a groupcast group by a sidelink groupcast transmission session. Also, UE 102 may transmit data to UE 101-B and UE 101-C by a sidelink broadcast transmission session.

Alternatively, according to some other embodiments of FIG. 1, UE 101-B functions as a Tx UE and transmits V2X messages, UE 101-A functions as an Rx UE and receives the V2X messages from UE 101-B.

Both UE 101-A and UE 101-B in the embodiments of FIG. 1 may transmit information to BS 102 and receive control information from BS 102, for example, via NR Uu interface. BS 102 may define one or more cells, and each cell may have a coverage area. As shown in FIG. 1, both UE 101-A and UE 101-B are within coverage of BS 102, and UE 101-C is not.

BS 102 as illustrated and shown in FIG. 1 is not a specific base station, but may be any base station(s) in the V2X communication system. For example, if the V2X communication system includes two B Ss 102, UE 101-A being within a coverage area of any one the two BSs 102 may be called as a case that UE 101-A is within a coverage of BS 102 in the V2X communication system; and only UE 101-C being outside of coverage area(s) of both BSs 102 can be called as a case that UE 101-C is outside of the coverage of BS 102 in the V2X communication system.

Power saving enables the UEs with battery constraint to perform sidelink operations in a power efficient manner. The NR sidelink communication in Release 16 is performed based on the assumption that the UE is “always-on”, e.g., only focusing on UEs installed in vehicles with sufficient battery capacity.

In Release 17, solutions for power saving are required for the vulnerable road users (VRUs) in V2X use cases and for the UEs in public safety and commercial use cases where power consumption in the UEs needs to be minimized.

Accordingly, one objective for power saving in Release 17 is for sidelink DRX, and corresponding working scope is as follows: regarding sidelink DRX for broadcast, groupcast, and unicast, 1) define on-durations and off-durations in sidelink and specify the corresponding UE procedure; 2) specify mechanism aiming to align sidelink DRX wake-up time among the UEs communicating with each other; and 3) specify mechanism aiming to align sidelink DRX wake-up time with Uu DRX wake-up time of an in-coverage UE.

The DRX configurations among the sidelink UEs need to be aligned such the data transmission would not be missed at the receiver's side; at the same time, power consumption of the receiver also needs to be minimized. In addition, the DRX configuration of a UE in a sidelink communication and the Uu configuration of the UE also need to be aligned.

Furthermore, only relying on the network configuration may not be enough for SL DRX, especially the configuration is tightly associated with traffic arrival time at the UE. The present disclosure proposes to further rely on the transmitting UE to transmit the SL DRX configurations to one or more receiving UEs.

In the present disclosure, the SL DRX configuration may include at least one of following parameters:
i) DRX cycle, e.g., long DRX cycle, or short DRX cycle, etc.;
ii) start offset of DRX, and slot start offset of DRX; and
iii) DRX related timers, for example, on-duration timer, inactivity timer, HARQ retransmission timer, HARQ RTT timer etc.

The SL DRX may also be referred to as: PC5 DRX, DRX on sidelink, DRX on PC5 interface, wake up time on sidelink, active time on sidelink, on/off duration on sidelink, monitoring period on sidelink, or the like.

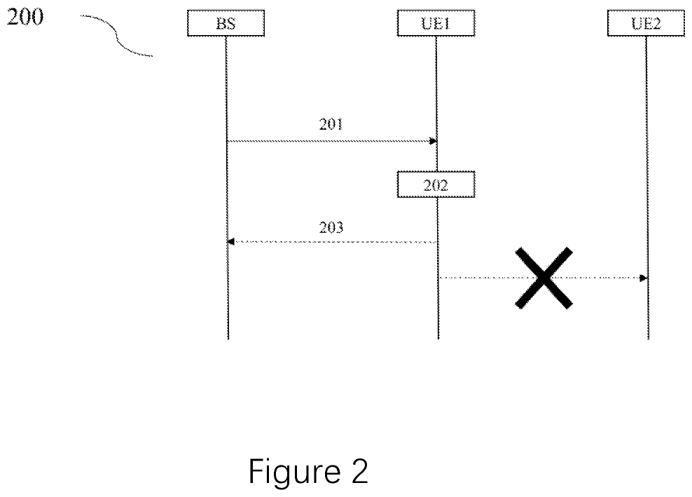

FIG. 2 illustrates a flow chart 200 illustrating one preferred method for aligning sidelink DRX according to some embodiments of the subject application.

In step 201, the BS may transmit the SL DRX configuration to the transmitting UE, UE1, via system information block (SIB), for example, SIB12; or a Radio Resource Control (RRC) configuration message, i.e., RRCReconfiguration message. In step 202, UE1 determines whether it is required, or allowed to transmit the SL DRX configuration to other UEs. For example, UE1 may be preconfigured to be required, or allowed to transmit the SL DRX configuration to other UEs, or may be preconfigured to be forbidden from transmitting the SL DRX configuration to other UEs.

Alternatively, whether UE1 is allowed to transmit, for example, broadcast the SL DRX configuration is under the control of the network. That is, the BS may use an indicator indicating whether the UE1 is required or allowed to transmit the SL DRX configuration. The indicator may be an RRC parameter, which has a size of 1 bit, and is broadcasted by the BS with other system information or transmitted to UE1 directly. In one embodiment, the value 1 of the RRC parameter is used to indicate that UE1 is required to transmit SL DRX configuration to other UEs, then UE1 needs to transmit SL DRX configuration to other UEs, and the value 0 is used to indicate that UE1 is not allowed to transmit SL DRX configuration to other UEs. The above rules might be reversed, that is, the value 0 indicates that UE1 is required to transmit SL DRX configuration, and the value 1 indicates UE1 is not allowed to transmit SL DRX configuration.

In another embodiment, the BS uses the RRC parameter to indicate whether the UE1 is allowed to transmit the SL DRX configuration. For instance, when the RRC parameter is set to 1, UE is allowed to transmit SL DRX configuration to other UEs, and the value 0 is used to indicate that UE1 is not allowed to transmit SL DRX configuration to other UEs. It should be noted that for a UE allowed to transmit the SL DRX configuration, it is not required to transmit the same. UE1 might not transmit the SL DRX configuration when it is allowed to. Similarly, the above rules might be reversed, that is, the value 0 indicates that UE1 is allowed to transmit SL DRX configuration, and the value 1 indicates UE1 is not allowed to transmit SL DRX configuration.

In FIG. 2, the UE is not allowed to transmit the SL DRX configuration to other UEs, and then UE1 can only apply the SL DRX configuration. When the BS transmits the SL DRX configuration to UE1 via RRC signalling, UE1 may transmit a feedback to BS in step 203.

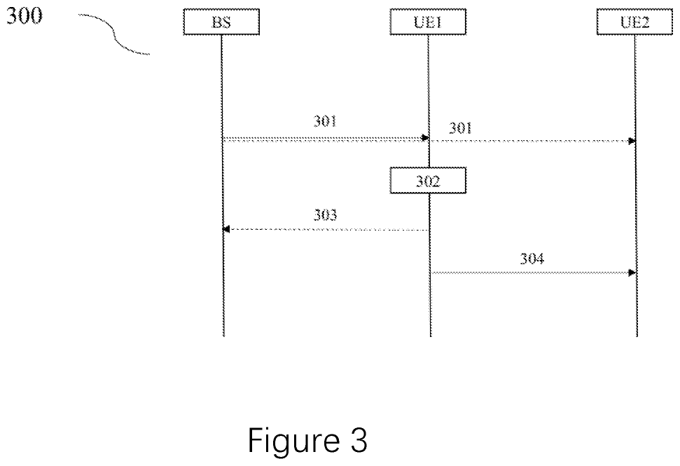

FIG. 3 illustrates a flow chart 300 illustrating another preferred method for aligning sidelink DRX according to some embodiments of the subject application.

In FIG. 3, UE1 is required, or allowed to transmit the SL DRX configuration to other UEs, e.g., UE2. Although only UE2 is shown in FIG. 3, it should be noted that UE1 may broadcast to SL DRX configuration to other UEs, UE3, UE4, etc. In step 301, the BS broadcasts the SL DRX configuration to the UEs, and both UE1 and UE2 receive the SL DRX configuration. If UE2 is out of coverage of the BS, UE2 cannot receive the SL DRX configuration. In step 302, UE1 determines that it is required, or allowed to transmit the SL DRX configuration to other UEs, then in step 304, UE1 transmits SL DRX configuration to UE2.

In one embodiment, the network, e.g., the BS may transmit an indicator indicating whether the UE1 is allowed to modify the received SL DRX configuration before broadcasting the SL DRX configuration. The indicator may be an RRC parameter, which has a size of 1 bit, and is broadcasted by the BS with other system information. The value 1 of the RRC parameter is used to indicate that UE1 is allowed to modify the SL DRX configuration before broadcasting the received SL DRX configuration to other UEs, and the value 0 indicates UE1 is not allowed.

Assuming the BS transmits the first SL DRX configuration, and UE1 broadcasts the second SL DRX configuration, when the value 1 of the RRC parameter is 1, this means that the first SL DRX configuration and the second SL DRX configuration may be different. When the value 1 of the RRC parameter is 0, UE1 is not allowed to modify the SL DRX configuration, thus the first SL DRX configuration and the second SL DRX configuration are identical. Similarly, it might be defined that the value 0 of the RRC parameter is used to indicate that UE1 is allowed to modify the SL DRX configuration before broadcasting the received SL DRX configuration to other UEs, and the value 1 indicates UE1 is not allowed to modify the SL DRX configuration.

In FIG. 3, UE2, which is the receiving UE, and applies SL DRX for SL reception, may receive SL DRX configuration from both the BS and UE1 when UE2 is in coverage of the BS. If the RRC parameter indicated by the BS allows UE1 to modify the SL DRX configuration, UE2 would ignore the first SL DRX configuration, which is the SL DRX configuration transmitted from the BS, and always apply the second SL DRX configuration for sidelink communication, which is transmitted from UE1. If UE2 does not receive any SL DRX configuration from UE1, UE2 will not enable SL DRX functionality.

The BS may use the RRC parameter to control the UEs to transmit the SL DRX configuration based on sidelink radio bearer (SLRB) configuration or destination ID. For example, the BS can configure a mapping relationship indicating which SLRB(s) or destination ID(s) is allowed to broadcast SL DRX configuration, and which SLRB(s) or destination ID(s) is not.

For example, if SLRB #1 and SLRB #2 are allowed to broadcast SL DRX configuration, SLRB #3 and SLRB #4 are not allowed. When UE1 has data transmission that associated with SLRB #1, SLRB #2, SLRB #3, and SLRB #4, then UE1 is only allowed to broadcast SL DRX configuration to other UEs for SLRB #1 and SLRB #2.

Similarly, if destination ID #1 and destination ID #2 are allowed to broadcast SL DRX configuration, destination ID #3 and destination ID #4 are not allowed. When UE1 has data transmission that associated with destination ID #1, destination ID #2, destination ID #3, and destination ID #4, then UE1 is only allowed to broadcast SL DRX configuration to other UEs for destination ID #1 and destination ID #2.

The BS may further use the RRC parameter to control the UEs to transmit the SL DRX configuration by threshold. More specifically, the BS can configure a threshold which is broadcasted together with other system information, for channel condition, reference signal receiving power (RSRP). That is, when RSRP of the serving cell of camped cell of the transmitting UE is lower than a threshold, then the transmitting UE is allowed to broadcast the SL DRX configuration to other UEs. In other words, the BS configures RSRP as a parameter to trigger the allowance of a transmitting UE to broadcast of the SL DRX configuration. When the measured RSRP if above the threshold, the transmitting UE is not allowed to broadcast SL DRX configuration. The threshold may also be configured by pre-configuring when UE is not in coverage and cannot receive configuration from network e.g. from the BS.

After UE1 determines that it would transmit the second SL DRX configuration, UE1 may transmit the second SL DRX configuration in different approaches.

For the first approach for transmitting the second SL DRX configuration, UE1 may transmit a SL DRX configuration index in MasterInformationBlockSidelink to UE2. UE1 may use reserved bits in MIB, namely, the MasterInformationBlockSidelink message, which has a size of 2 bits. UE1 may also transmit the SL DRX configuration index in medium access control (MAC) control element or sidelink physical layer control channel. Each index corresponds to one SL DRX configuration. For example, index 00 may correspond to the SL DRX configuration with i) long DRX cycle, ii) start offset of DRX, and iii) on-duration timer; index 01 may correspond to the SL DRX configuration with i) short DRX cycle, ii) start offset of DRX, and iii) on-duration timer; index 10 may correspond to the SL DRX configuration with i) long DRX cycle, ii) slot start offset of DRX, and iii) inactivity timer; and index 11 may correspond to the type of SL DRX configuration with i) long DRX cycle, ii) slot start offset of DRX, and iii) HARQ RTT timer. It should be noted that the above SL DRX configurations are some examples of the mapping relationship between the index and the SL DRX configuration, and other mapping relationship also apply in this present disclosure.

The SL DRX configuration corresponding to SL DRX configuration index may be configured by network in system information; alternatively, it can be configured in pre-configuration stored in the UE.

In this embodiment, UE2, the receiving UE, is a power sensitive UE and is enabled with SL DRX, always receive and decode MIB, i.e. MasterInformationBlockSidelink, in Physical Sidelink Control Channel (PSBCH) according to the configured time frequency resource. If MasterInformationBlockSidelink is received, then the receiving UE will decode the reserved bits field, i.e. reservedBits field. According to the value of the reserved bits, UE2 is aware of the SL DRX configuration index, and obtains the SL DRX configuration based on the mapping relationship. The UE2 applies the SL DRX configuration. This means in the following time, UE2 will only monitor sidelink control channel in active time according to applied SL DRX configuration.

For the second approach for transmitting the second SL DRX configuration, SL DRX configuration information is broadcasted by UE1 in an independent time-frequency resource. The independent time-frequency resource is configured by network or is pre-configured in UE, and might be carried in Physical Sidelink Control Channel (PSBCH) or Physical Sidelink Shared Channel (PSSCH). The SL DRX configuration information includes at least one of following information:
i) a SL DRX configuration index;
ii) a full SL DRX configuration, i.e., all parameters that relate to SL DRX configuration, e.g. DRX cycle, start offset, and DRX related timers, etc.
iii) a partial SL DRX configuration, i.e., at least one DRX parameter that relates to SL DRX configuration, that is, at least one of DRX cycle, start offset, and DRX related timers, etc.

In this embodiment, UE2 is a power sensitive UE and is enabled with SL DRX, and always receive and decode SL DRX information broadcasted in pre-configured time frequency resource. If SL DRX configuration is received, then UE2 will apply the SL DRX configuration. Based on the above three forms of the SL DRX configurations, UE2 determines the SL DRX configuration in the following three different ways:

First, if only a SL DRX configuration index is received, UE2 will determine the SL DRX configuration corresponding to the SL DRX configuration index. As explained above, the mapping relationship between the SL DRX configuration index and the SL DRX configuration corresponding may be configured by network in system information, alternatively, it can be configured in pre-configuration stored in the UE.

Second, when a full SL DRX configuration is received, UE2 will directly apply full SL DRX configuration.

Third, when a partial SL DRX configuration is received, UE2 will determine the SL DRX configuration based on: i) the SL DRX configuration in network configuration or in pre-configuration, or previous applied SL DRX configuration, and ii) the at least one DRX parameter in partial SL DRX configuration. This means, the at least one DRX parameter in the partial SL DRX configuration will replace the corresponding DRX parameter in the SL DRX configuration in network configuration, in pre-configuration, or previous applied SL DRX configuration

For the third approach for transmitting the second SL DRX configuration, the SL DRX configuration information is broadcasted by the transmitting UE in a sidelink SIB on sidelink. At least 1 bit in the MIB, i.e. MasterInformationBlockSidelink, is used to indicate whether there is a following SIB for SL DRX configuration. Besides, there will have at least a parameter with a size of 1 bit in the MIB, to indicate whether the content of the SIB is changed or not. The time-frequency resource of this SIB might:
i) have fixed location relative to PSBCH;
ii) in network configured or preconfigured resource location, or
iii) be indicated in MIB.

The content of the SIB might include at least one of following information:
i) a SL DRX configuration index;
ii) a full SL DRX configuration, i.e., all parameters that relate to SL DRX configuration, e.g. DRX cycle, start offset, and DRX related timers, etc.; and
iii) a partial SL DRX configuration, i.e., at least one DRX parameter that relates to SL DRX configuration, that is, at least one of DRX cycle, start offset, and DRX related timers, etc.

In this approach, UE2, which is power sensitive UE and is enabled with SL DRX, would always receive and decode the MIB, i.e. MasterInformationBlockSidelink, in PSBCH, and check whether there is SL SIB for SL DRX configuration, or whether the content of SL SIB is updated, according to corresponding indicator in the MIB. If yes, UE2 will receive SL SIB for SL DRX configuration, and then determine to apply the SL DRX configuration in a similar fashion as in the above mentioned second approach.

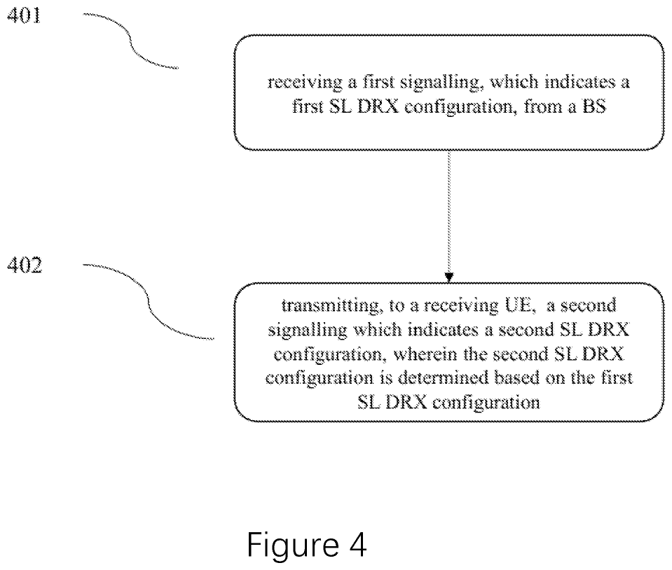

FIG. 4 illustrates a method performed by a transmitting UE for aligning sidelink DRX according to some embodiments of the subject disclosure.

In step 401, the transmitting UE receives a first signalling, which indicates a first SL DRX configuration, from the BS. The transmitting UE may also receive an indicator, for example, an RRC parameter, which indicates whether the transmitting UE is allowed to transmit the second signaling to the receiving UE. If the transmitting UE is allowed to transmit the second signaling to the receiving UE, then in step 402, the transmitting UE transmits a second signalling which indicates a second SL DRX configuration to a receiving UE. The second SL DRX configuration is determined based on the first SL DRX configuration.

That is, the transmitting UE may receive an indicator transmitted from the BS, which indicates whether the transmitting UE is required or allowed to modify the first SL DRX configuration or not. If the transmitting UE is required or allowed to modify the first SL DRX configuration, then the second SL DRX configuration may be different from the first SL DRX configuration. If not, then the second SL DRX configuration and the first SL DRX configuration are identical.

The transmitting UE may still receive indicator, i.e., the RRC parameter, transmitted from the BS, which indicates that the transmitting UE is allowed to transmit the second signaling to the receiving UE for the one or more destination IDs, or to the receiving UE for the one or more SLRBs. For example, if SLRB #1 is allowed while SLRB #2 is not allowed to broadcast SL DRX configuration, when UE1 has data transmission that associated with SLRB #1, and SLRB #2, then UE1 is only allowed to broadcast SL DRX configuration to other UEs for SLRB #1, not SLRB #2.

Alternatively, the transmitting UE may transmit the second signalling to the receiving UE if the transmitting UE determines that a reference signal receiving power of a serving cell or a camped cell, e.g., RSRP measured by the transmitting UE is lower than a threshold.

The detailed information of the SL DRX configuration includes: at least one parameter selected from a group including: a DRX cycle, a start offset of DRX, a slot start offset of DRX, and a DRX related timer.

The second signaling may be an index of SL DRX configuration, corresponding to the second SL DRX configuration, and transmitted in a sidelink master information block, in sidelink MAC control element, or in sidelink physical layer control channel. A plurality of SL DRX configurations with a plurality of indexes are configured by the BS or preconfigured. Alternatively, the second signaling may be transmitted to the receiving UE in an independent time-frequency resource which is configured by BS or preconfigured or specified.

The second signaling might include an index of SL DRX configuration, a full SL DRX configuration, or a partial SL DRX configuration.

The second signaling might include an index of SL DRX configuration, corresponding to the second SL DRX configuration, in a SL SIB. A parameter in the SL MIB indicates whether the SL SIB indicates SL DRX configuration information. A parameter in the MIB indicates whether information of SL DRX configuration in the SL SIB is changed.

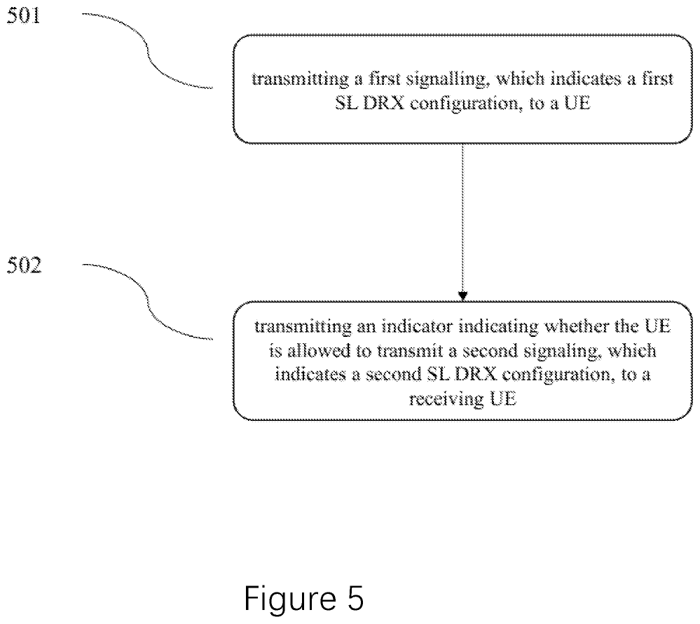

FIG. 5 illustrates a method performed by a BS for aligning sidelink DRX according to some embodiments of the subject disclosure. In step 501, the BS transmits a first signalling, which indicates a first SL DRX configuration, to a UE; and in step 502, the BS transmits an indicator indicating whether the UE is allowed to transmit a second signaling, which indicates a second SL DRX configuration, to a receiving UE. The BS may further transmit an indicator indicating a threshold of reference signal receiving power.

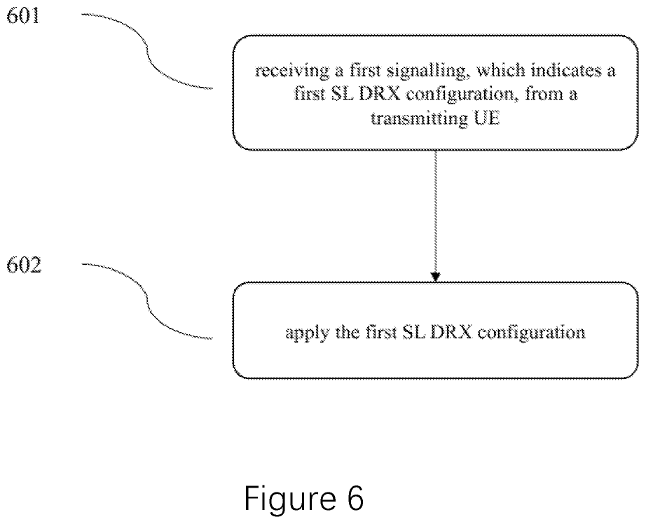

FIG. 6 illustrates a method performed by a receiving UE for aligning sidelink DRX according to some embodiments of the subject disclosure. In step 601, the receiving UE receives a first signalling, which indicates a first SL DRX configuration, from a transmitting UE. In step 602, the receiving UE applies the first SL DRX configuration for the sidelink communication.

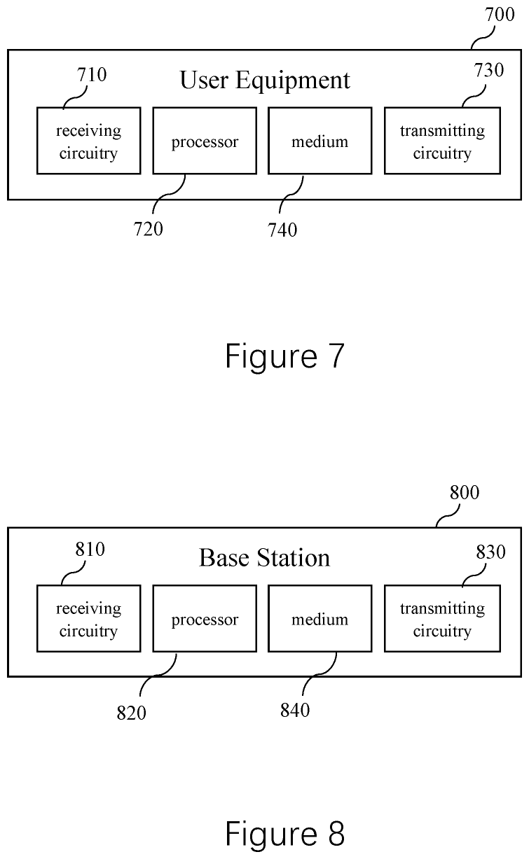

FIG. 7 illustrates a block diagram of a UE 700 according to the embodiments of the subject disclosure. The UE may include a receiving circuitry 710, a processor 720, and a transmitting circuitry 730. In one embodiment, the UE may include a non-transitory computer-readable medium 740 having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g., the method in FIG. 4) with the receiving circuitry, the transmitting circuitry and the processor.

FIG. 8 illustrates a block diagram of a BS 800 according to the embodiments of the subject disclosure. The BS may include a receiving circuitry 810, a processor, 820 and a transmitting circuitry 830. In one embodiment, the BS may include a non-transitory computer-readable medium 840 having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g., the method in FIG. 5) with the receiving circuitry, the transmitting circuitry and the processor.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1.-32. (canceled)

33. A transmitting User Equipment (UE), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry, wherein the computer-executable instructions cause the processor to implement a method, the method comprising:
receiving a first signalling, which indicates a first sidelink (SL) discontinuous reception (DRX) configuration, from a Base Station (BS); and
transmitting, to a receiving UE, a second signalling which indicates a second SL DRX configuration, wherein the second SL DRX configuration is determined based on the first SL DRX configuration.

34. The transmitting UE of claim 33, further comprising:
receiving, from the BS, an indicator indicating whether the transmitting UE is allowed to transmit the second signaling to the receiving UE.

35. The transmitting UE of claim 33, further comprising:
receiving, from the BS, an indicator indicating whether the transmitting UE is allowed to determine the second SL DRX configuration by modifying the first SL DRX configuration.

36. The transmitting UE of claim 33, further comprising:
receiving, from the BS, an indicator for one or more destination IDs indicating whether the transmitting UE is allowed to transmit the second signaling to the receiving UE for the one or more destination IDs.

37. The transmitting UE of claim 33, further comprising:
receiving, from the BS, an indicator for one or more sidelink radio bearers (SLRBs) indicating whether the transmitting UE is allowed to transmit the second signaling to the receiving UE for the one or more sidelink radio bearers (SLRBs).

38. The transmitting UE of claim 33, wherein transmitting the second signaling comprises:
transmitting the second signaling to the receiving UE if the transmitting UE determines that a reference signal receiving power of the transmitting UE lower than a threshold.

39. The transmitting UE of claim 33, wherein the second SL DRX configuration includes at least one parameter selected from a group including: a DRX cycle, a start offset of DRX, a slot start offset of DRX, and a DRX related timer.

40. The transmitting UE of claim 33, wherein the second signaling comprises:
an index of SL DRX configuration, corresponding to the second SL DRX configuration, in a sidelink master information block, in sidelink medium access control (MAC) control element, or in sidelink physical layer control channel.

41. The transmitting UE of claim 33, wherein the second signaling is transmitted to the receiving UE in an independent time-frequency resource which is configured by BS or preconfigured or specified.

42. The transmitting UE of claim 33, wherein the second signaling includes an index of SL DRX configuration, corresponding to the second SL DRX configuration, in a sidelink system information block (SL SIB).

43. A Base Station (BS), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry, wherein the computer-executable instructions cause the processor to implement a method, the method comprising:
transmitting a first signalling, which indicates a first sidelink (SL) discontinuous reception (DRX) configuration, to a User Equipment (UE); and
transmitting an indicator indicating whether the UE is allowed to transmit a second signaling, which indicates a second SL DRX configuration, to a receiving UE.

44. The BS of claim 43, further comprising:
transmitting an indicator indicating whether the UE is allowed to modify the first SL DRX configuration.

45. The BS of claim 43, further comprising:
transmitting an indicator for one or more destination IDs indicating whether the transmitting UE is allowed to transmit the second signaling to the receiving UE for the one or more destination IDs.

46. The BS of claim 43, further comprising:
transmitting an indicator for one or more sidelink radio bearers (SLRBs) indicating whether the transmitting UE is allowed to transmit the second signaling to the receiving UE for the one or more sidelink radio bearers (SLRBs).

47. The BS of claim 43, further comprising:
transmitting an indicator indicating a threshold of reference signal receiving power.

48. The BS of claim 43, wherein the first SL DRX configuration includes at least one parameter selected from a group including: a DRX cycle, a start offset of DRX, a slot start offset of DRX, and a DRX related timer.

49. A receiving User Equipment (UE), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry, wherein the computer-executable instructions cause the processor to implement a method, the method comprising:
receiving a first signalling, which indicates a first sidelink (SL) discontinuous reception (DRX) configuration, from a transmitting UE.

50. The receiving UE of claim 49, wherein the first SL DRX configuration includes at least one parameter selected from a group including: a DRX cycle, a start offset of DRX, a slot start offset of DRX, and a DRX related timer.

51. The receiving UE of claim 49, wherein the first signalling comprises:
an index of SL DRX configuration, corresponding to the first SL DRX confirmation, in a master information block, in mandatory access control (MAC) control element, or in SL physical layer control channel.

52. The receiving UE of claim 49, wherein the first signaling is received in an independent time-frequency resource which is configured by BS or preconfigured or specified.
